(19) United States
(12) Patent Application Publication
(10) Pub. No.: US 2013/0013215 A1
(43) Pub. Date: Jan. 10, 2013

(54) COMPUTATIONAL METHODS FOR PROTEIN STRUCTURE DETERMINATION

(75) Inventors: Charles Michael Fortmann, Bellport, NY (US); Yeona Kang, Coram, NY (US)

(73) Assignee: The Research Foundation of State University of New York, Albany, NY (US)

(21) Appl. No.: 13/571,589

(22) Filed: Aug. 10, 2012

Related U.S. Application Data
(63) Continuation-in-part of application No. PCT/US2011/024294, filed on Feb. 10, 2011.
(60) Provisional application No. 61/303,468, filed on Feb. 11, 2010.

(51) Int. Cl. G06F 19/10

(52) U.S. Cl. 702/19

(57) ABSTRACT

A screening method for determining secondary structures of a protein or polypeptide without performing computer simulation, is provided. The screening method is based in part on the interaction between the electrostatic forces and the electrostatic displacement forces in the protein, and makes use of a set of computational conditional statements. The screening method includes determining both alpha helix and beta sheet structures based on hydrophobic character and charges of the residues, among other considerations. A method for determining an overall folded structure of a protein using a physics-based simulation method with an initial configuration of the protein prepared according to the secondary structure(s) determined by the screening method, is also provided.

### CROSS-REFERENCE TO RELATED APPLICATIONS

This application is a continuation-in-part application of International Application No. PCT/US11/024,294, filed Feb. 10, 2011, which claims priority to U.S. Application Ser. No. 61/303,468 filed Feb. 11, 2010, the disclosure of each of which is hereby incorporated by reference in its entirety.

### BACKGROUND

The secondary and higher-order structures of a protein dictate its function and biological activity, and are therefore important to many fundamental life processes. Such structures can be determined experimentally through, for example, crystallography or Nuclear Magnetic Resonance Spectroscopy (NMR). However, these experimental techniques are often limited to small-sized proteins. The sample preparation, data gathering and spectra interpretation for these techniques are usually highly time-consuming and complex.

In recent years, computational methods for protein structure prediction have been gaining increasing importance in structural biology. Current approaches to computational analysis often rely on comparisons to previously described (experimentally determined) sequences and structures. One of such approaches is homology modeling, which is based on sequence or structural alignment of the protein or polypeptide with a “template” protein that has a known structure. However, for a protein of interest, a suitable template for homology analysis may be difficult to find, especially in the case of a novel artificial protein. Furthermore, even if such template can be found, an amino acid sequences to be analyzed may have different degrees of divergence from the template, and sequence homology modeling may be unable to predict the structure of those portions of the sequence that are unmatched by the template or their influence on the structure matched portions.

Alternatively, physics-based computational methods have been employed for protein structure determination. These methods include energy minimization, which is not able to sample the vast conformational space of a protein to obtain its native structure, and molecular dynamics simulations, which are computational resource-intensive and therefore can be limited to small proteins (or fractions of larger proteins) and short timescale molecular phenomena.

Physics-based computational methods for determining protein secondary structures are disclosed in International Application PCT/US07/067,639 (the '639 application), filed Apr. 27, 2007, published as WO/2007/140061 and entitled “A Method For Determining And Predicting Protein Autonomous Folding,” the disclosure of which is hereby incorporated by reference in its entirety. The '639 application makes use of an energy-coupled mobility term in multi-energy fields, which relates response speed to energy gradients. The energy gradients have two components: the first energy gradient is the electric field and the second is molecular free energy (with all electrostatic components removed):

$$VP - ST + {\sum }_{j} {φ}_{{L}_{j}} {n}_{j} . \qquad ( 1 )$$

where V is volume, P is pressure, S is molecular (global) entropy, T is temperature (degrees Kelvin), φ_{L}_{ⱼ} are various non-electrostatic energy terms relating to one or more identifiable molecular constituents, nⱼ. The mobility term is derived based on a condition where the drift of a charged particle in an electric field gradient and its diffusion in free energy gradient reaches an equilibrium, and therefore, the term does not explicitly incorporate electrostatic interactions.

In particular, with D being the diffusion constant, k being the Boltzman constant, the concentration of a charged species of interest being nₚ, the energy-coupled mobility of the charged species is:

$$μ = \frac{D ∇ ln ( {n}_{p} )}{∇ \{ VP - ST + {\sum }_{j} {φ}_{{L}_{j}} {n}_{j} \} + kT ∇ ln {n}_{p}} . \qquad ( 2 )$$

The computational method of the '639 application employs an effective force based on the energy-coupled mobility and thermal mobility to transform a protein molecule in a computer simulation to its folded structure.

There exists a need for a further refinement of physics-based computational method to improve their efficiency and accuracy for predicting the secondary and higher-order structure of a protein or polypeptide sequence.

### SUMMARY

The disclosed subject matter provides efficient computational methods for determining and/or predicting the secondary or higher-ordered structures of a protein or polypeptide. The method is based, in part, on the recognition of the role of various considerations, including different forces as well as the size of the residues, in determining the secondary structures of a protein or polypeptide. One of such forces is short-range repulsive force that repels non-polar residues from the vicinity of highly charged residues.

In one aspect, the disclosed subject matter provides a screening method for determining secondary structures of a protein without performing computer simulation. The screening method is based in part on the interaction between the electrostatic forces and the electrostatic displacement forces in a subsequence on the protein, and makes use of a set of computational conditional statements. The screening method can include determining both alpha helix and beta sheet structures. The alpha helix determination can include searching for an opening hydrophilic residue and a closing hydrophilic residue spaced by the intervening residues. The opening and closing hydrophilic residues together with the intervening residues define a bracket of residues, and are subject to queries or evaluations using one or more of factors relating to the charge, hydrophobic character, and in some cases, the size (or mass) of the bracketed residues to determine the existence of an alpha helix. The beta sheet determination can include a comparison between the sum of charges of a consecutive sequence of residues and the sum of the hydrophobic character of the sequence. The screening method can be carried out by one or more computing devices, such as desktop computers, work stations, super computers, etc. The computing devices can include processors and computer-readable storage media (e.g., transient and permanent memories), where the processors can be configured to receive instructions loaded on the computer-readable storage media to perform the method.

In a further aspect, the disclosed subject provides a computational method for determining an overall folded structure of a protein or polypeptide. The computational method can makes use of the various forces described above, and can include the screening method to prepare an initial secondary structure of a protein for further simulation. The computational method can provide accurate three dimensional description of a protein, including its tertiary structure, in a highly efficient manner.

### BRIEF DESCRIPTION OF THE DRAWINGS

FIG. 1 is a diagram illustrating a computational method for determining the structure of a protein according to one embodiment of the disclosed subject matter;

FIG. 2 is a diagram illustrating a method for determining an alpha helix in a protein according to one embodiment of the disclosed subject matter;

FIG. 3 is a diagram illustrating a method for determining a beta sheet in a protein according to one embodiment of the disclosed subject matter;

FIG. 4 is a diagram of denoted secondary structures of a protein determined by a method according to one embodiment of the disclosed subject matter as compared to the structure determined experimentally;

FIGS. 5A-5C are plots demonstrating the prediction accuracies of proteins according to one embodiment of the disclosed subject matter; and

FIGS. 6A-6C are screenshots of an overall structure of a protein as determined experimentally (6A), as determined by a method according to one embodiment of the disclosed subject matter (6B), and a superposition (6C) of the two structures as depicted in (6A) and (6B).

### DETAILED DESCRIPTION

The presently disclosed subject matter provides a computational method for determining and/or predicting secondary and/or higher-ordered structures of a protein or polypeptide molecule, or any portion thereof, based on considerations of effective forces including explicit electrostatic interactions as well as thermal mobility.

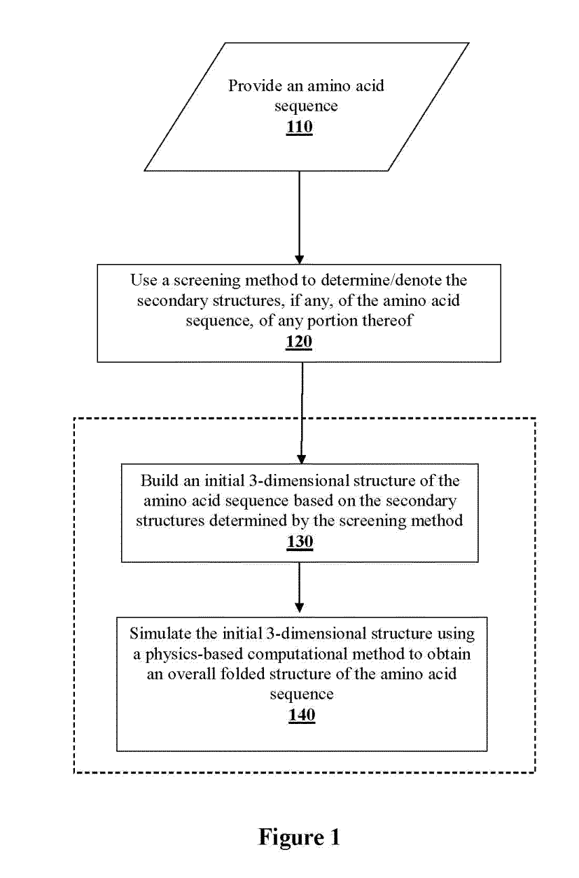

As depicted in FIG. 1, the computational method includes screening (120) for determining the secondary structures of an amino acid sequence provided (110), and optionally, building an initial 3-dimensional structure of the amino acid sequence (130) based on the secondary structure determined, and simulating the initial 3-dimensional structure using a physics-based simulation method to obtain an overall folded structure of the amino acid sequence (140).

The computational method is based on the understanding that three forces play a central role in protein structure: the electrostatic force, an electrostatic displacement force, and a thermal energy related force. Global entropy change can also be considered a force (the fourth force).

The first force, electrostatic force between two charged bodies, can be determined from Coulomb's law using an appropriate dielectric constant. For example, the dielectric constant of water can be used.

The second force, electrostatic displacement force, refers to a force generated by an electric field acting on a mobile polar media (e.g., liquid water) which is in the direction towards lower electric field strength on mobile non-polar objects. This force, which involves the structural coupling between transporting neural ionic charge and the vapor filled neighboring alpha helix neural structure, is described in Kang and Fortmann, “A Structural Basis for the Hodgkin and Huxley Relation” Appl. Phys. Lett. (2007) 91:223903-05, the contents of which are incorporated by reference herein. This coupling arises through the electrostatic interaction among water, point charge electric field

$$( \vec{E} = \frac{q}{4 πɛ {r}^{2}} ) ,$$

and the vapor filled and/or vapor-like nature of hydrophobic (non-polar) residues that make up the core of neighboring alpha helices.

The reduction in electrostatic field energy generated by an external point charge, W, from when a non-polar species (or a dielectric object) is in an electric field in water (dielectric constant, ∈_{w}) to when the non-polar species is replaced with water, results in a force that pulls water toward the electric field and thereby pushes non-polar matter away from the electric field. This displacement force can be calculated by:

$$\begin{matrix}W = - \frac{1}{2} {\int }_{{V}_{1}} ( {ɛ}_{w} - {ɛ}_{0} ) \vec{E} \cdot {\vec{E}}_{0} d V \approx - \frac{1}{2} ( {ɛ}_{w} - {ɛ}_{0} ) \vec{E} \cdot {\vec{E}}_{0} Δ V \approx \frac{- {β}_{0} {\vert q \vert}^{2}}{{r}^{4}} & ( 3 ) \\ Force = - \frac{\partial W}{\partial r} = \frac{β {\vert q \vert}^{2}}{{r}^{5}} & ( 4 )\end{matrix}$$

where the subscript 0 denotes electric field strength or dielectric constant at vacuum, and the integration is over the volume of the non-polar protein region.

Here the polarity of the displaced objects is assumed to be water vapor having the permittivity of space, ∈₀ and where the volume of the objects and the other constants have been collected in parameter β. It is noted that in Eq. 4, the force is derived approximately as proportional to the inverse of the distance between the non-polar object and the external point charge to the 5th power. However, the force can also be described generally as being proportional to 1/r^{z}, where z is a real number greater than 3, for example, from 3 to 6. The magnitude of the displacement forces acting upon a completely charge-neutral alpha helix sized object under the influence of an electronic point charge at about 0.1 nm distance is comparable to the Coulomb force between two opposite point charges a similar distance.

The third force arises from the thermal energy. This thermal energy force relates to the average motion of one part of the protein relative to another arising from diffusion. There are several possible formulations for the thermal energy force, of which one particularly simple formulation relates the thermal diffusion speed,

$$v = \sqrt{D / τ} {}_{μ \to D / kT} \sqrt{μ kT / τ} ,$$

to the force needed to produce the same speed through drift (where drift speed≡μ∇φ_{eff} when the effective thermal force is ∇φ_{eff}).

Combining the above three forces, the effective force acting on a portion of the protein relative to another portion can be expressed by:

$$F = [ \frac{{q}_{1} {q}_{2}}{4 πɛ {r}^{2}} ] + [ \frac{β {\vert q \vert}^{2}}{{r}^{5}} ] + \sqrt{kT / μτ} {}_{\sqrt{1 / μτ \to γ}} [ \frac{{q}_{1} {q}_{2}}{4 π ɛ {r}^{2}} ] + [ \frac{β {\vert q \vert}^{2}}{{r}^{5}} ] + γ \sqrt{kT} \qquad ( 5 )$$

where τ is a time step or unit time, and γ is constant close to unity (alternatively, the energy-coupled mobility μ described in Eq. 2 can be used explicitly without making the approximation of γ). The first term of Eq. 5 (Coulomb) includes forces between a charge and any polar structure, including those that have net neutral charge, where the attraction of unlike charges and the repulsion of like charges will always orient a polar structure in a way that generates attractive force. The fourth force, the global entropy temperature product can be incorporated into the mobility.

While it is well known that hydrophobic residues can aggregate to form the core of an alpha helix, many regions of a protein having large numbers of closely spaced hydrophobic (non-polar) residues do not form alpha helices. This can be understood in terms of the repulsive force (or displacement force) as described by the second term of Eq. 5. Hydrophobic residues tend to aggregate whenever in close proximity to reduce interfacial energy with water unless blocked from doing so. When a sufficiently large charge exists in the intervening protein segments (e.g., charged residues) the repulsive component generates a large repulsive force. Since both hydrophobic residues are repelled by the same intervening charge(s), hydrophobic-hydrophobic residue aggregation is blocked, and the two hydrophobic residues are forced to separate (displaced) by incoming water drawing by the charge.

An additional consideration unrelated to force for determining the secondary structure of a protein can be included to account for the size effect of large residues. It has been found by the current inventors that alpha helix can be blocked from forming by large sized residues on the sequence concerned (a form of steric hindrance).

Eq. 5 can operate on all size scales. On small size scales, Eq. 5 can be used to determine the conditions for the formation of secondary structures. On larger size-scales, the expression guides the generation of tertiary structures by determining the force between charged protein residues outside of the secondary structures and the secondary structures as a unit.

Based on the above considerations, including the relationship of forces described in Eq. 5, folded structures, e.g., secondary structure and/or higher ordered structures, of proteins can be determined using a detailed model of particle motion in appropriate fields with the appropriate constraint for protein backbone motion. For example, the computational methods for incorporating the forces into internal molecular rotation as described in the '639 application can be used. The relative location of residues and the hydrophobic and charge characteristics of each residue can be used as input parameters.

The method for the determination of the folded structure of a protein can include first determining or denoting secondary structures of the protein according to a screening method that does not require simulation but instead makes use of a set of computational conditional statements. The screening method can be based, in part, on the interplay between the electrostatic forces (the first term in Eq. 5) and the electrostatic displacement force (the second term in Eq. 5) of a subsequence on the protein. The screening method can be implemented in a computer program based on the following considerations.

The screening method includes first determining alpha helix regions, and then determining the beta sheet regions of a protein. Before the alpha helix and beta sheet determination procedure, all the residues on the given amino acid sequence can be denoted unstructured.

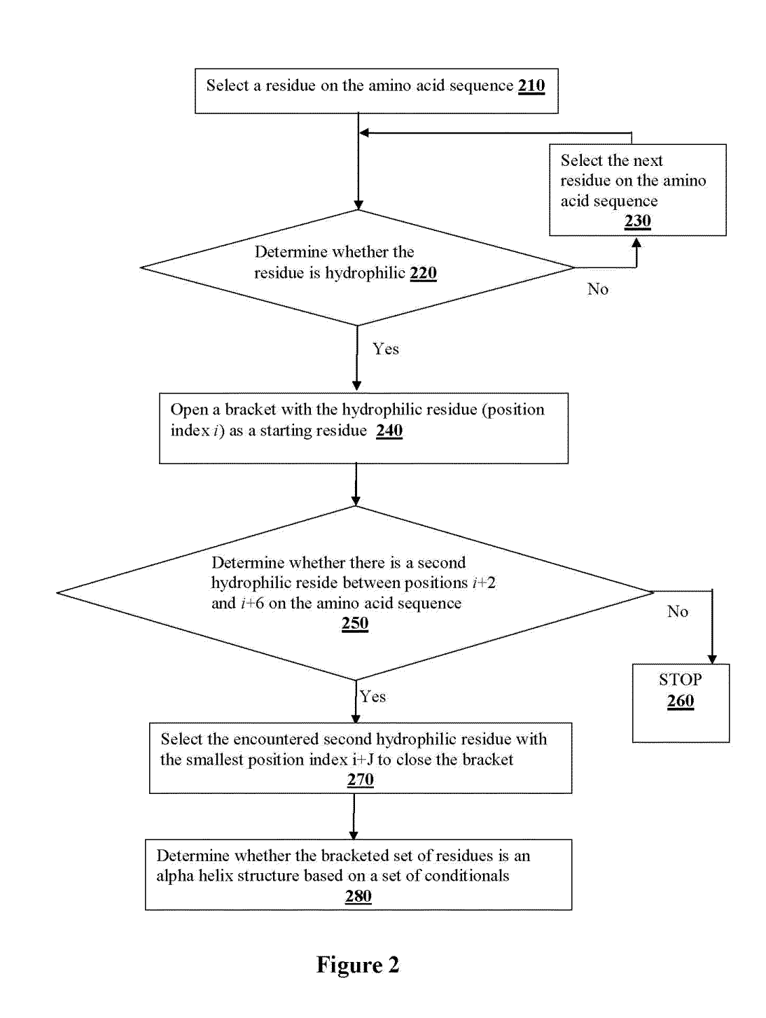

FIG. 2 is a diagram illustrating the procedure for determining an alpha helix region according to one embodiment of the screening method. A residue on the amino acid sequence is first selected (210). If the residue is hydrophobic, the next residue is selected (230). The procedure is repeated until a hydrophilic residue is encountered. Whether a residue is hydrophilic can be determined by its hydrophobic character. The hydrophobic character and charge of amino acid residues are well known and can be found in the literature, e.g., Copeland, R. A., 1994, Methods for Protein Analysis, a practical guide to laboratory protocols, Chapman & Hall, New York, where positive values indicate hydrophilic residues and negative indicates hydrophobic residues.

Upon encountering a hydrophilic residue (i-th residue, denoted nᵢ), a scanning bracket is opened (240). The next neighbor amino in the sequence (nᵢ₊₁) is not queried. The following five amino acids in sequence (nᵢ₊₂, nᵢ₊₃, . . . nᵢ₊₆) are queried to determine if there is a second hydrophilic residue (250). If a second hydrophilic residue cannot be found in the sequence (nᵢ₊₂, nᵢ₊₃, . . . nᵢ₊₆), this procedure stops (260). Otherwise, the first occurrence of such a second hydrophilic residue marks the end point of the bracket (n_{i+J}) (270). The screening method then checks the bracketed set against one or more of the following conditional rules (280). When any of these rules is tested true, the bracketed set is determined to be an alpha helix region.

The first rule involves testing whether there are a sufficient number of hydrophobic residues to aggregate into an alpha helix in the bracket. This can be described by a condition where the cumulative hydrophobic character,

$${\sum }_{k = i + 1}^{k = i + ( J - 1 )} {h}_{k} ,$$

is smaller than a first preset threshold value Γ₁. For example, Γ₁ can be set to be −3×(J−1).

The second rule involves testing whether the summed charge of the residues within the bracketed set,

$${\sum }_{k = i + 1}^{k = i + ( J - 1 )} {q}_{k} ,$$

is smaller than a second preset threshold, Γ₂, i.e., For

$${\sum }_{k = i + 1}^{k = i + ( J - 1 )} {q}_{k} < {Γ}_{2} .$$

example, Γ₂ can be selected to be 0.8 e, where e is the charge of an electron. Under this condition, the bracketed region can be determined to be an alpha helix, as the repulsive component of the electrostatic interaction (Eq. 5) between a charge and a hydrophobic residue is not large enough to prevent the closely spaced hydrophobic residues from aggregating into an alpha helix.

The third rule involves testing whether a large number of residues having the same charge sign that are capable of forming an exterior shell within which hydrophobic residues can aggregate. This condition is expressed as

$${\sum }_{k = i + 1}^{k = i + ( J - 1 )} {q}_{k} > {Γ}_{3} ,$$

where Γ₃ can be set at approximately 1.5 e.

Additionally, separate considerations for the formation of alpha helices can be applied to bracketed sets containing three or four residues. For the case of a three residue bracketed set, if qᵢ, qᵢ₊₁, and qᵢ₊₂ all have the same sign, and either |qᵢ₊₁|>|qᵢ|&|qᵢ₊₁|>|qᵢ₊₂| or |q₁₊₁|<0.2e & mᵢ₊₁<100 (m is the mass of a residue, in Daltons), the region can be determined to be an alpha helix region. A three residue helix can also be determined to be present when qᵢ and qᵢ₊₂ have opposite signs and |qᵢ₊₁|>0.11e.

For a bracketed set containing four residues, when the two interior hydrophobic residues are oppositely charged, alpha helix can form under two conditions: (1) when the two interior residues are both strongly hydrophobic (e.g., hᵢ₊₁, hᵢ₊₂<−3); (2) when the charges of the two interior residues are sufficiently small (e.g., |qᵢ₊₁|, |qᵢ₊₂|0.5e).

In specific embodiments for a 3-residue bracket, a 5-residue bracket and a 7-residue bracket, an alpha helix can be determined based on the conditionals tabulated in Table 1, where each row independently identifies a conditional sufficient to determine an alpha helix. The summation of charges (Table 1 column 1) determines the overall charge and therefore the magnitude of the electric field exerting repulsive force on hydrophobic residues, a force that opposes hydrophobic residue aggregation and therefore alpha helix formation. The product of charge, as shown in column 2, is positive when there are equal numbers of same charged residues, and negative otherwise. This product of charge when combined with the summation of charge relates to the magnitude of electrostatic attractive (or repulsive) force. The summation of hydrophobic character (last column) is an indication of the net hydrophobic attractive force operating within the region of concern.

TABLE 1
Conditions for forming an alpha helix for different bracket sizes

| Case | $a = {\sum }_{k = i}^{i + n} {q}_{k}$ | ${\prod }_{k = i}^{i + 2} {q}_{k}$ | Other qₖ condition | ${\sum }_{k = i}^{i + n} {h}_{k}$ |
|---|---|---|---|---|
| n = 1 | 0 < a < 0.2 | >0 | qₖ > 0.9 where k = 1 | <−3.0 |
| | <−0.5 | ≠0 | | |
| | 0 < a < 0.5 | <0 | | |
| n = 3 | >1 | | qᵢ₊₂ ≠ qᵢ₊₃ | <−6.0 |
| | \|a\| < 0.5 | | | |
| | >0 | | | |
| n = 5 | 0.3 < a < 0.5 | | qₖ > 0, k = i + 1, . . . , i + 5 | |
| | \|a\| > 1.0 | | \|qᵢ₊₂\|, \|qᵢ₊₃\|, \|qᵢ₊₄\| > 0.6 | |

In Table 1 above, qₖ is partial charge of k^{th} residue, hₖ is hydrophobicity of k^{th} residue, and n is the number of residues intervening the two boundary hydrophilic residues defining the bracket.

The above procedure for determining an alpha helix can be used to determine whether there is an alpha helix region in any portion of interest on the given amino acid sequence. In order to obtain all of the alpha helix regions, the procedure can be repeated by scanning through the entire amino acid sequence. Thereafter, the determination of a beta sheet region can be initiated.

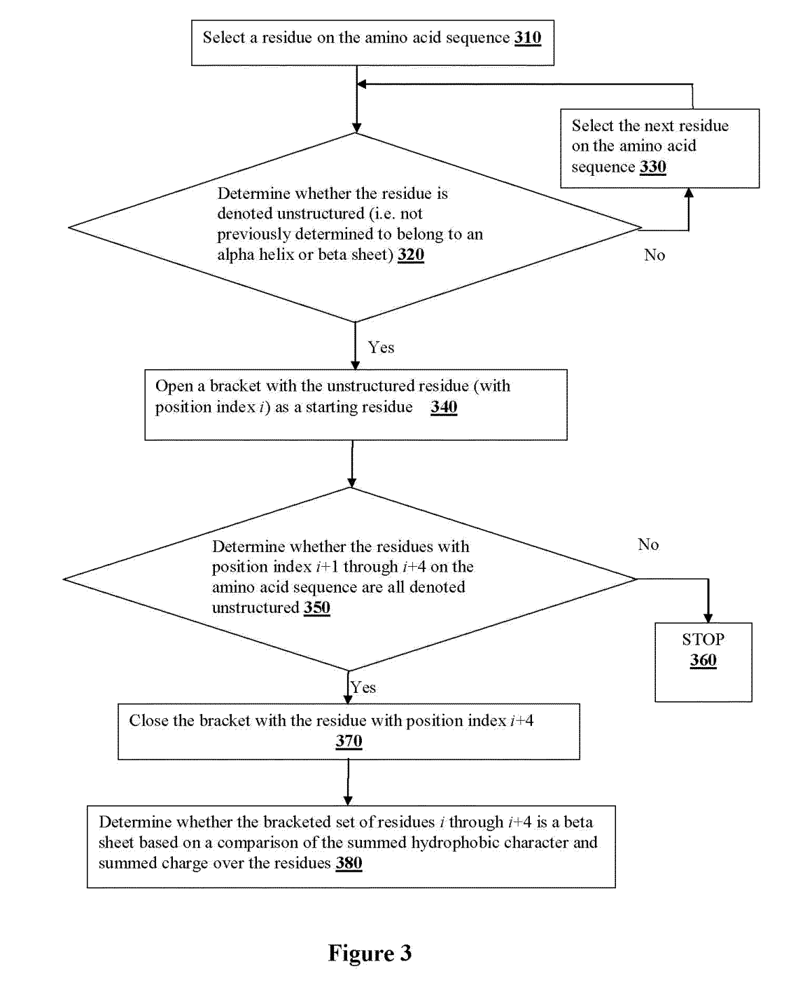

FIG. 3 is a diagram illustrating how a beta sheet can be determined within an exemplary screening method. A residue on the amino acid sequence is first selected (310). If the residue is denoted unstructured (i.e., it is not previously determined to belong to an alpha helix or beta sheet region, 320), the next residue is selected (330). The procedure is repeated until an unstructured residue n, is encountered. A scanning bracket is opened using this unstructured residue as a starting residue (340), and its next 4 consecutive residues (nᵢ₊₁ through nᵢ₊₄) are queried to determine if they are all unstructured (350). If the answer is no, the procedure is stopped (360). Otherwise, a scanning bracket of residues nᵢ through nᵢ₊₄ is established (370). Beta sheet determination is then performed (380) based on the summation of the magnitude of charges and the summation of the hydrophobic character of each residue in the 5-residue bracket. For example, such a 5-residue bracket is determined to be a beta sheet when

$${\sum }_{i}^{i + 4} \vert {q}_{i} \vert - 0.1 {\sum }_{i}^{i + 4} {h}_{i} < 0.3 and {\sum }_{i}^{i + 4} {h}_{i} > 0.1 .$$

The above procedure for beta sheet determination can be repeated for the entire amino acid sequence to obtain all of the beta sheet structures on the sequence.

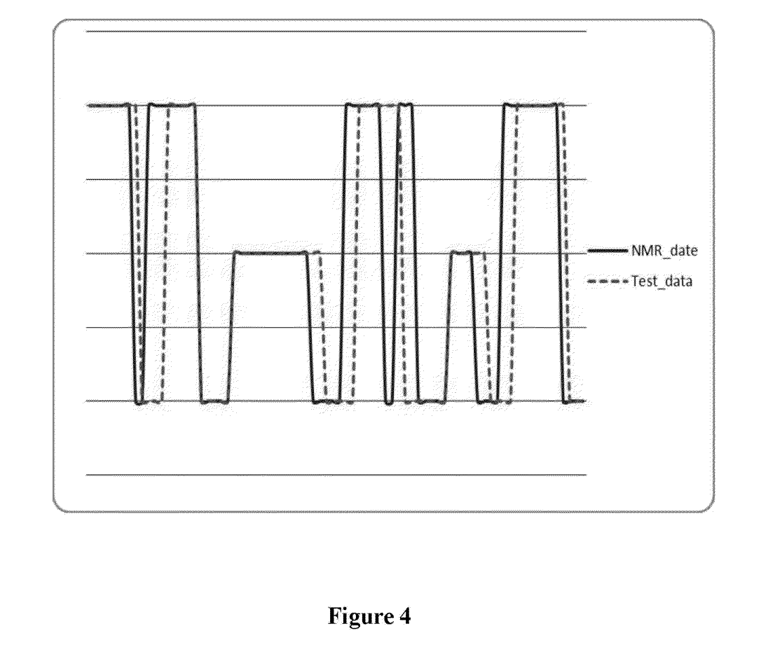

FIG. 4 shows the results of the screening method performed on Ubiquitin, represented by the dashed line, as compared with its secondary structure determined by NMR, represented by the solid line. The horizontal axis represents the amino acid residue index number on the Ubiquitin sequence, and the vertical axis represents the denotation of each amino acid residue on the Ubiquitin sequence as either belonging to an alpha helix (an assigned value of 1), a beta sheet (value of 2), or an unstructured region (value of 0). As can be seen in FIG. 4, the screening method of the disclosed subject matter correctly identifies most of the secondary structure of Ubiquitin. It is important to note that the experiment itself can have a relatively large margin of error, which can be attributed to data interpretation, thermal fluctuations, and end point constraint on natural proteins (e.g., a residue neighboring an alpha helix may be physically close enough to be confused with an actual helix structure that is characterized by reduced energy). Considering these errors, the secondary structure determined according to the screening method approximates the accuracy of experimental results.

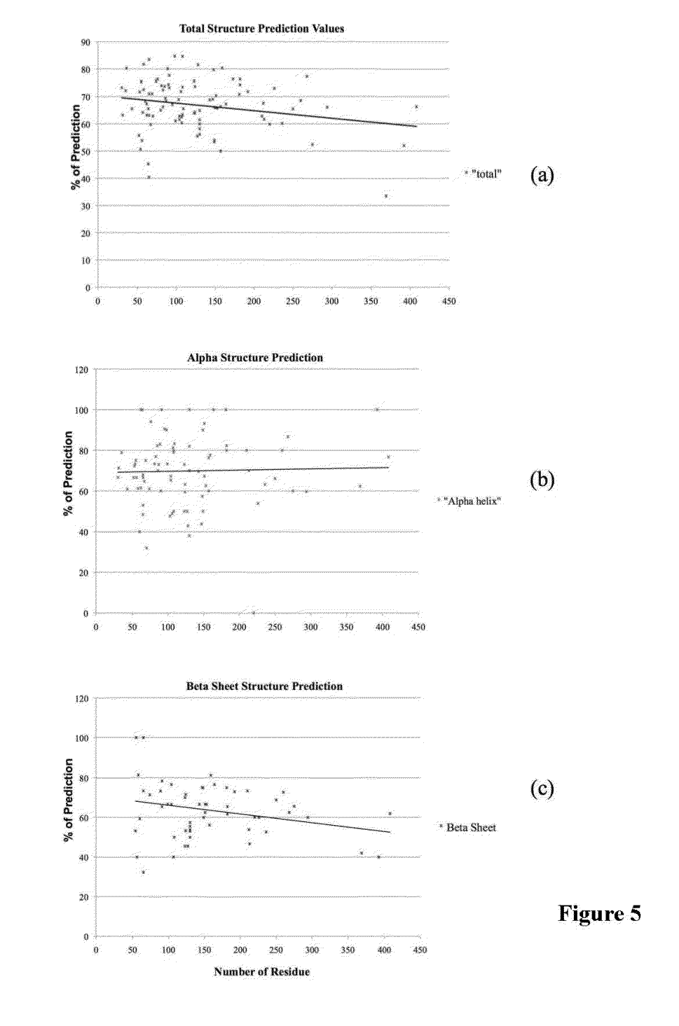

FIGS. 5A-5C show the results of secondary structure prediction using the disclosed screening method for a wide cross-section of proteins. The reference (experimental) structure was obtained from Rost, B., “Review: Protein secondary structure prediction continues to rise”, J. Struct. Bio., no. 134, pp 204-218, 2001. The screening method found essentially all of the secondary structures and correctly determined their character. The accuracy of this procedure has been tested on hundreds of proteins producing accuracies of ˜70±9% for alpha helix and ˜66±14% for beta sheet identification (residue-by-residue comparison between model and experimental for proper secondary structure assignment). The core secondary structure identification has greater accuracy: ˜75±7% and ˜70±12% for helices and beta-sheet respectively.

Further, Table 2 below compares the accuracy of the disclosed screening methods relative to another popular model as embodied in commercial PSIPRED described in the literature. The commercial PSIPRED is based on recognized (statistically analyzed) correlations between a given amino acid sequence and the corresponding experimentally determined structure, and does not depend on physical parameters or perform physics-based calculations. Reference for theoretical background of the PSIPRED program can be found in Jones D T, (1999) Protein secondary structure prediction based on position-specific scoring matrices. J Mol Biol 292:195-202. Again, the data in the table demonstrate the accuracy of the screening method in secondary structure determination.

TABLE 2
Performance of the screening method on a selection of proteins

| | Experimental | | | | | | |
|---|---|---|---|---|---|---|---|
| | Techniques | | KM | KM | | | PSI |
| | Used to | KM* | % of | % of | PSI** | PSI | % of |
| | Determine | % of | Correctly | Correctly | % of | % of | Correctly |
| | Secondary | Correctly | Predicted | Predicted | Correctly | Correctly | Predicted |
| | Structures | Predicted | Beta- | Alpha | Predicted | Predicted | Alpha |
| Proteins | (As Reference | Residues | Sheet | Helix | Residues | Beta-Sheet | Helix |
| (PDB#) | Standard) | (Total) | Residues | Residues | (Total) | Residues | Residues |
| 1hdn | NMR | 73.8 | 78.5 | 82.26 | 89 | 88 | 93 |
| 1ubq | X-RAY | 76.32 | 72.73 | 94.11 | 82 | 73 | 77 |
| 1vii | NMR | 72.2 | non | 78.95 | 80 | non | 100 |
| 2nmq | NMR | 64.18 | 65.38 | non | 60 | 54 | non |
| 1pba | NMR | 74.04 | non | 73.33 | 68 | non | 70 |
| 1aps | NMR | 84.7 | 80 | 90 | 80 | 83 | 87 |
| 1aey | NMR | 67.3 | 77.8 | non | 44 | 35 | non |
| 1coa | NMR | 45.31 | 71.05 | 61.53 | 81 | 60 | 92 |
| 1fkb | NMR | 61.61 | 72.97 | 100 | 88 | 90 | 100 |
| 1mjc | NMR | 71.01 | 80.64 | non | 69 | 70 | non |
| 1nyf | NMR | 59.73 | 40 | 70 | 62 | 54 | 0 |
| 1pks | NMR | 65 | 53.57 | 64.75 | 59 | 48 | 0 |
| 1shg | X-RAY | 63.2 | 61.23 | non | 42 | 25 | non |
| 1srl | NMR | 65.56 | 75 | 100 | 53 | 37 | 0 |
| 1ten | X-RAY | 74.44 | 68 | non | 80 | 85 | non |
| 1ycc | X-RAY | 63.4 | 58.58 | 60.01 | 51 | 0 | 53 |
| 2ci2 | NMR | 66.26 | 64.34 | 79.84 | 47 | 28 | 0 |
| Avg | | 67.59 | 67.99 | 79.98 | 66.76 | 55.33 | 51.69 |

*“KM” means the screening method of the disclosed subject matter.
**“PSI” means PSIPRED, noted above.

After determining all the alpha helix and beta sheet structures of an amino acid sequence using the above-described screening method, an initial three dimensional representation (or conformation) of the sequence can be built with the amino acid residues with the appropriate geometries required by the alpha helices and beta sheets as determined. The portion of the protein not belonging to any determined alpha helix or beta sheet, i.e., the unstructured portion, can be built as a linear chain, or in an arbitrary physically permissible conformation. Residue properties including charge, hydrophobic character, mass, etc., can be assigned to an appropriate alpha-carbon atom of each residue of the protein. In addition, for each alpha helix or beta sheet identified in the screening method, the alpha helix or beta sheet can be tagged accordingly with aggregate or summed properties (summed charges, summed hydrophobic character, etc.).

Physics-based computer simulations can then be employed based on the above initial conformations and assigned properties to obtain the tertiary or higher-order structures of the amino acid sequence, as shown in FIG. 1. For example, the methods described in the '639 application for rotating the protein along torsional angles on the protein backbone using effective torques can be used to fold the protein to obtain an overall folded protein structure. Each secondary structure identified in the screening method can be treated as a unit with the summed properties, in which case the internal conformation of these secondary structures are not allowed to change during the simulated folding. This leads to fast convergence of the computational method to arrive at a stable conformation, where higher-ordered structure can be determined. For example, if a physics-based simulation method of the '639 application (i.e., the method based on the mobility of Eq. 2 to account for global factors and the forces represented by Eq. 5) is used, the simulated folding can converge in less than a minute of a desktop computer CPU time to arrive at RMSD values in the 4-5 Å as compared to an experimentally determined structure. Simulations of approximately 10-20 Kilo-Dalton proteins on a desktop computer can predict the full three dimensional protein tertiary structure with RMSD values in the 5-10 Angstroms range. Alternatively, the secondary structures can be allowed to change in the simulated folding to examine the influences of the chain segments surrounding the secondary structures on the secondary structures in the folding process.

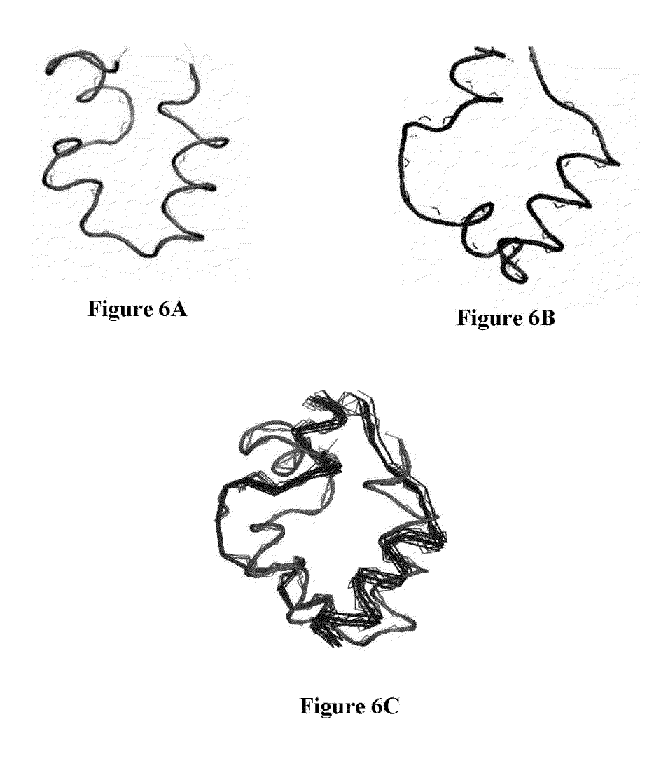

FIG. 6 shows a comparison of the overall structure of protein Villin as determined experimentally by NMR (in 6A), and by the physics-based computational method as described above (6B). The superposition (6C) of the structures of 6A and 6B indicates that the method of the disclosed matter has reproduced substantially the “real” structure of Villin.

Table 3 below shows the simulation result of various proteins ranging from 30 to 157 amino acid sequences from physics-based model of the disclosed subject matter using the structures determined by PSIPRED as a reference. Average RMSD value for these sequences relative to experiment (NMR data) was found to be 4.9±1.08 Å. The largest protein reported was the human protein tyrosin phosphotome with 320 amino acids. The method of the disclosed subject matter produced a RMSD value of ˜8 Å. This value is reasonable relative to alternative ab-initio methods for a protein of this size. The RMSD values can be further improved by using molecular dynamics to relax the simulated results, for example, by the AMBER program running on a computer (e.g., a supercomputer).

TABLE 3
The tertiary structure simulation
results from physics-based models after
secondary structure determination

| | | Secondary | |
|---|---|---|---|
| | | Structure | |
| | No. of | Prediction | |
| Proteins | Residues | (% accuracy) | RMSD (Å) |
| 2MHU | 30 | 73.3 | 3 |
| 1VII | 35 | 72.2 | 4.8 |
| 3CBH | 36 | 75.3 | 4.3 |
| 3RNT | 54 | 61.65 | 4.1 |
| 1DUR | 55 | 74.45 | 3.7 |
| 1OVO | 56 | 53.9 | 5.8 |
| 1BW6 | 56 | 70 | 6.1 |
| 2NMQ | 57 | 86 | 5.8 |
| 2UTG | 70 | 62.85 | 3.8 |
| 1UBQ | 76 | 77.63 | 5.4 |
| 2PCY | 99 | 61.1 | 4 |
| 5CYT | 103 | 68.94 | 4.7 |
| 7RSA | 124 | 73.7 | 5.1 |
| 2PAB | 127 | 55.5 | 4.2 |
| 2CCY | 128 | 81.56 | 6.3 |
| 2SNS | 149 | 54.02 | 6.7 |
| 1AAQ | 157 | 73 | 6.2 |
| AVG | 83.06 | 69.94 | 4.94 |

The methods of the disclosed subject matter can take an arbitrary amino acid sequence as input, and can therefore be used to classify, identify, and investigate shape change dynamics of any given protein or polypeptide. The methods can further be used to gain insight into function-structure relationship, such as the effects of mutation on the structure and function of a protein.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous systems and methods which, although not explicitly shown or described herein, embody the principles of the disclosed subject matter and are thus within its spirit and scope. For example, use of different physical parameters for the forces as described in Eq. 5 is contemplated.

1. A method for determining a structure of an amino acid sequence, comprising, by one or more computing devices:
selecting a first hydrophilic residue having position index i in the amino acid sequence;
determining whether there is a second hydrophilic residue having a position index of between i+2 and i+6 on the amino acid sequence;
when there is a second hydrophilic residue between position indices i+2 and i+6, selecting the second hydrophilic residue having the smallest position index i+J, where 2≦J≦6, and determining whether the amino acid residues within the bracket between position index and to index i+J belong to an alpha helix according to a set of conditionals relating to the hydrophobic character and/or charge of the residues in the bracket.

2. The method of claim 1, wherein the set of conditionals include a conditional based on a summation of charge of each of the intervening residues in the bracket.

3. The method of claim 1, wherein the set of conditionals include a conditional based on a summation of hydrophobic character of the intervening residues in the bracket.

4. The method of claim 1, further comprising determining whether a residue in the amino acid sequence that has been determined to be unstructured according to the alpha helix determination belongs to a beta sheet.

5. The method of claim 4, wherein determining whether an unstructured residue belongs to a beta sheet includes comparing a summation of the magnitude of charge of each of five consecutive unstructured residues with a summation of hydrophobic character of each of such five consecutive unstructured residues.

6. The method of claim 4, further comprising determining each residue of the amino acid sequence as belonging to an alpha helix, belonging to a beta sheet, or unstructured.

7. The method of claim 6, further comprising:
building an initial three dimensional configuration of the amino acid sequence based on the alpha helix (or helices), beta sheet(s), or the unstructured residues previously determined; and
performing a physics-based simulation on the amino acid sequence to determine an overall folded structure of the amino acid sequence.

8. The method of claim 7, wherein the physics-based simulation treats any alpha helix or beta sheet region previously determined as a single unit.

9. The method of claim 8, wherein the physics-based simulation employs summed properties for the alpha helix or beta sheet.
